(19) United States
(12) Patent Application Publication
(10) Pub. No.: US 2020/0047279 A1
(43) Pub. Date: Feb. 13, 2020

(54) FRICTION STIR WELDING MACHINES AND METHODS

(71) Applicant: SPIRIT AEROSYSTEMS, INC., WICHITA, KS (US)

(72) Inventor: Heath Edward Misak, Wichita, KS (US)

(73) Assignee: SPIRIT AEROSYSTEMS, INC., WICHITA, KS (US)

(21) Appl. No.: 16/100,450

(22) Filed: Aug. 10, 2018

(51) Int. Cl. B23K 20/12; B23K 20/26

(52) U.S. Cl. CPC B23K 20/123; B23K 2101/18; B23K 20/26; B23K 20/1245

(57) ABSTRACT

A friction stir welding machine and method that injects filler materials into a weld joint and determines the amount of materials to add by monitoring and compensating for insufficient internal weld pressures in the joint. Two workpieces are placed adjacent one another in an abutting relationship with a joint formed between them. A pin tool is inserted in the joint, rotated, and moved along the joint as the pin is rotating so as to mix and heat materials in the joint. Internal weld pressures in the joint adjacent the pin tool are monitored, and filler materials are injection into the joint when an internal weld pressure below a threshold weld pressure is detected.

### BACKGROUND OF THE INVENTION

The present invention relates to friction stir welding machines and methods for joining workpieces. More particularly, the invention relates to a machine and method for monitoring and compensating for insufficient weld pressures in a joint between adjacent workpieces during a friction stir welding procedure.

Friction stir welding is a process of welding two or more workpieces together and/or repairing cracks in a single workpiece using friction heat generated by a rotating pin tool. The pin tool is inserted into a joint between the workpieces, or a damaged section of a single workpiece, and then rotated and moved to generate friction heat and mix the materials in the workpiece or workpieces to form a plasticized region along the joint or damaged workpiece.

A typical self-reacting friction stir welding pin tool includes an upper shoulder and a lower shoulder that together sandwich the workpiece or workpieces to be welded. The upper and lower shoulders can be fixed relative to one another or movable relative to one another by actuators to accommodate workpieces of different thicknesses and to apply forging forces and pinch forces to the workpieces. The frictional heat generated by the pin tool is a function of the rotational speed of the pin, the transverse speed of the pin tool, and the forging forces of the upper and lower shoulders.

The strength of a friction stir weld is partially dependent on the fit-up of the joined workpieces. When the workpieces have chips, non-planar edges, or other material voids, they often don't align properly and have gaps between them. These gaps are typically at least partially filled by the mixing of the materials by the rotating pin tool, but the gaps provide less material to mix and therefore often contribute to worm holes or other voids in the welded joint. These voids reduce the strength of the weld and are often difficult to detect and fix.

Attempts have been made to remedy the above-described problems by injecting filler materials into a weld joint during friction stir welding. But determining the proper amount of material to add is difficult. U.S. Pat. No. 8,397,974 discloses a friction stir welding tool in which varying amounts of filler material are injected into a weld based on the measured thickness of the workpieces being joined, but this method is often ineffective because the thickness of workpieces is not related to the presence of the above-described fitment problems, as workpieces of uniform thicknesses can still have non-planar edges, gaps, and other voids that provide less material to mix.

Accordingly, there is a need for improved friction stir welding machine and method for reducing weld problems caused by poor workpiece fitment issues.

### SUMMARY OF THE INVENTION

The present invention solves the above-described problems and provides a distinct advance in the art of friction stir welding machines and methods. More particularly, the invention provides a friction stir welding machine and method that determines the amount of filler materials to add to a weld joint by monitoring and compensating for insufficient internal weld pressures in the weld joint.

One exemplary embodiment of the invention is a method of joining two workpieces via friction stir welding. The method comprises placing the workpieces adjacent one another in an abutting relationship with a joint formed therebetween; inserting a pin tool in the joint; rotating the pin of the pin tool; and moving the pin tool along the joint as the pin is rotating so as to mix and heat materials in the joint between the adjacent workpieces. In accordance with aspects of the present invention, the method also comprises monitoring internal weld pressures in the joint and injecting metal materials into the joint when the monitoring step detects a weld pressure below a threshold weld pressure.

In some embodiments, the injecting step comprises extruding powdered metal materials into the weld joint. The metal materials are held in a chamber and extruded into the weld joint through an injection port by a plunger positioned in the chamber. In these and other embodiments, the monitoring step may comprise monitoring back pressures exerted on the plunger by the metal materials in and around the injection port. This back pressure is representative of the internal pressures in the weld joint. When the monitored pressure drops below a threshold amount, which indicates a low internal weld pressure caused by insufficient materials in the weld joint, the method injects more metal materials into the weld joint. This actively adjusts for low weld pressures in the weld joint by injecting metal materials into the joint to compensate for gaps, voids, and other material deficiencies in and near the joint.

These and other important aspects of the present invention are described more fully in the detailed description below.

### BRIEF DESCRIPTION OF THE DRAWING FIGURES

Embodiments of the present invention are described in detail below with reference to the attached drawing figures, wherein:

FIG. 1 is a schematic perspective view of selected components of a friction stir welding machine constructed in accordance with embodiments of the present invention.

FIG. 2 is a fragmentary vertical cross sectional view of a portion of the friction stir welding machine.

FIG. 3 is a block diagram of selected control components of the friction stir welding machine.

FIG. 4 is a flow diagram of selected steps in a method of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

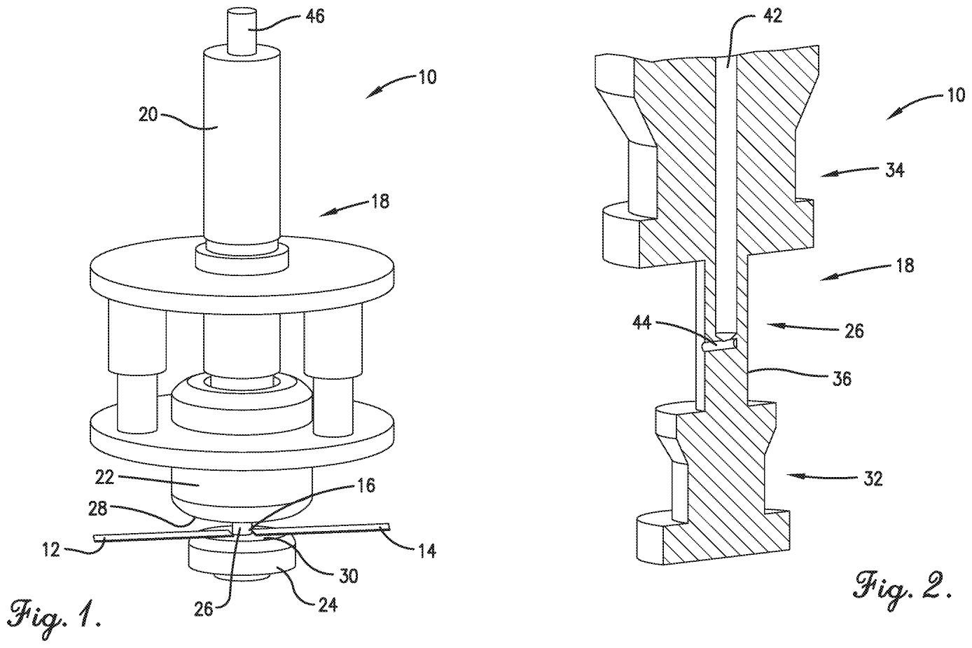

Turning now to the drawing figures, and particularly FIGS. 1 and 2, a friction stir welding machine 10 constructed in accordance with a embodiments of the present invention is illustrated. The friction stir welding machine 10 can be used to join two adjacent workpieces 12,14, such as metal skin panels of an aircraft, or can also be used to repair cracks in a single workpiece. The exemplary illustrated workpieces 12,14 are shown in a abutting relationship with a joint 16 between them.

The friction stir welding machine 10 includes a rotatable pin tool 18 attached to or formed with a spindle 20. An embodiment of the rotatable pin tool 18 includes an upper shoulder 22, a lower shoulder 24, and a pin 26 extending between the shoulders. The upper shoulder 22, lower shoulder 24, and pin 26 are preferably formed of a material or materials having high strength and heat resistance such as tool steel or various metallic or non-metallic alloys.

The upper shoulder 22 may be formed in a variety of shapes and sizes, and in one embodiment, is generally cylindrical with a central longitudinal bore through which the pin 26 extends. The upper shoulder has a lower face 28 for abutting the upper surface of the workpieces 12, 14 to be welded as illustrated in FIG. 1. In one embodiment, the lower face 28 is concave-shaped so as to carry stirred material along the weld line, reduce the amount of material that extrudes from the sides of the shoulder, and maintain downward pressure, and hence good forging, of the material trailing the pin tool, but it may be formed in any shape and size.

The lower shoulder 24 may also be formed in a variety of shapes and sizes, and in one embodiment, is generally cylindrical. The lower shoulder 24 has an upper face 30 for abutting the lower surface of the workpieces 12, 14 as illustrated in FIG. 1. As with the lower face 28 of the upper shoulder 22, the upper face 30 of the lower shoulder 24 may be concave-shaped so as to carry stirred material along the weld line, reduce the amount of material that extrudes from the sides of the shoulder, and maintain pressure, and hence good forging, of the material trailing the pin tool.

The pin 26 rotates between the shoulders 22, 24 and as best illustrated in FIG. 2, has first and second ends 32, 34 and an intermediate stirring portion 36 therebetween. The first end 32 is attached to or otherwise coupled with the lower shoulder 24. In some embodiments, the lower shoulder 24 is supported on the pin 26 by a bearing assembly so that the pin 26 may rotate relative to the lower shoulder. In other embodiments, the pin 26 may be integrally formed with the lower shoulder 24 such that the lower shoulder and pin rotate together.

The second end 34 of the pin 26 extends through the central bore of the upper shoulder 22 and may be coupled with a bearing assembly so that the pin 26 may rotate relative to the upper shoulder 22. In other embodiments, the pin 26 may be integrally formed with the upper shoulder 22 such that the upper shoulder and pin rotate together.

The stirring portion 36 is the portion of the pin 26 that welds the joint 16 between the workpieces 12, 14. The stirring portion 36 may be cylindrical, non-cylindrical, tapered, triangular-shaped, or of any other geometry.

The pin tool 18 is attached to or integrally formed with the spindle 20. The spindle may have independently rotatable and axially translatable portions so as to rotate the pin 26. The spindle 20 may also be attached to or otherwise coupled to the upper shoulder 22 and/or lower shoulder 24 so as to rotate one or both shoulders.

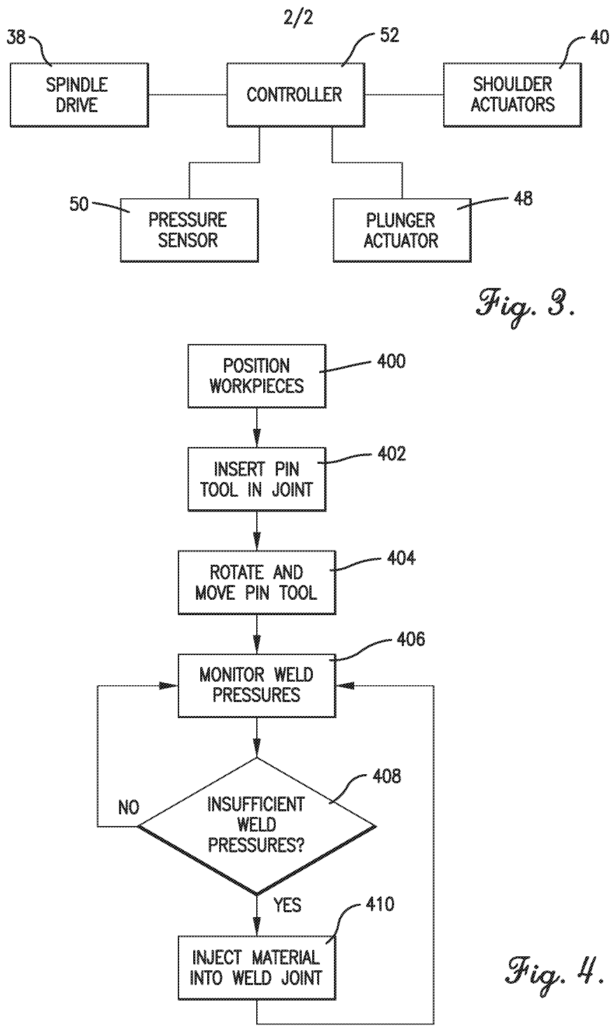

As shown in FIG. 3, an embodiment of the friction stir welding machine 10 also comprises a spindle drive 38 linked or otherwise coupled to the spindle 20 so as to rotate the pin 26. The spindle drive 38 may also rotate the upper and/or lower shoulders 22, 24 in embodiments where the shoulders rotate with the pin. The spindle drive 38 and spindle 20 may be configured to rotate only one of the upper or lower shoulders or may rotate both together or independently (e.g., different speeds and/or different directions).

As also shown in FIG. 3, an embodiment of the friction stir welding machine 10 further comprises one or more shoulder actuators 40 linked or otherwise coupled to the upper shoulder 22 and/or the lower shoulder 24 to move the shoulders up or down relative to one another. During welding, the shoulder actuators 40 may move the upper and lower shoulders toward one another until they sandwich or pinch the workpieces 12, 14 with a desired amount of forging forces.

In accordance with aspects of the present invention, the friction stir welding machine 10 also comprises an additive material assembly. The additive material assembly holds and injects metal filler materials into a weld joint during a welding procedure to compensate for insufficient weld pressures adjacent the rotating pin 26. An embodiment of the additive material assembly comprises a material chamber 42, an injection port 44 on one end of the chamber 42, and a plunger 46 on the opposite end of the chamber as illustrated in FIGS. 1 and 2. The additive material assembly also comprises a plunger actuator 48, a pressure sensor 50, and a controller 52 as illustrated in FIG. 3.

The material chamber 42 holds a supply of filler materials such as powdered metals to be injected into the weld joint 16. The chamber may be of any size and shape and may be separate from or integrally formed with the pin tool 18. As shown in FIG. 2, an embodiment of the material chamber 42 is formed inside the pin tool. With this configuration, the chamber 42 and the filler materials in the chamber are conductively heated by friction heat generated during a welding process so as to pre-heat the filler materials. In other embodiments, the filler materials may be pre-heated by an external heating source.

In other embodiments, portions of the material chamber 42 may be separate from, and connected to, the portions of the material chamber shown in FIG. 2 so as to increase the total volume of the material chamber.

The injection port 44 connects the material chamber 42 to the surface of the pin 26 so as to allow filler materials to be injected in the weld joint 16. The injection port may have a valve that can be opened and closed or may be sized and configured to hold materials in the chamber without a valve when the plunger is not activated by the plunger actuator 48.

The plunger 46 is located on one end of the chamber 42 and may be moved in and out of the chamber to extrude the filler materials out of the injection port 44 and into the weld joint 16. The plunger 46 is moved by the plunger actuator 48. The plunger actuator 48 may be an electro-mechanical screw-type device or any other device that can be controlled by the controller 52 to move the plunger 46 and eject filler materials out of the injection port 44.

The pressure sensor 50 measures or approximates the weld pressures adjacent the pin during a welding procedure to determine when filler materials should be added to the weld joint 16. In one embodiment, the pressure sensor 50 is attached to or otherwise coupled with the plunger 46 and monitors back pressures on the plunger 46 caused by materials adjacent the rotating pin 26. When insufficient materials are in the weld zone 16 around the rotating pin, the back pressures are relatively lower. Conversely, when ample materials are in the weld zone, the back pressures are relatively higher. Other embodiments of the invention may measure internal weld pressures in different ways. For example, one or more pressure sensors may be mounted directly to the rotating pin or one of the shoulders.

The controller 52 controls delivery of filler materials into the weld joint 16 and controls other operations of the friction stir welding machine in accordance with operator instructions. For example, the controller 52 may be coupled with the spindle drive 38 and the shoulder actuators 40 to control the various rotational and translational movements of the pin tool 26. During a welding operation, the controller 52 causes the shoulder actuators 40 to apply forging forces on the upper and lower shoulders 22, 24, causes the spindle drive 38 to rotate the pin 26, and causes the pin tool 18 to move along the joint 16 between the workpieces 12, 14. The controller 52 may also include or be coupled with various force transducers, pressure sensors, displacement sensors, or equivalent devices for measuring the amount of forging and pinching forces applied on the upper and lower shoulders 22, 24 by the shoulder actuators 40.

In accordance with aspects of the present invention, the controller 52 is also coupled with the plunger actuator 48 and the pressure sensor 50 to control the rate at which filler materials are injected into the weld joint 16 to compensate for insufficient weld pressures in the weld joint. To determine how much filler materials to inject in the weld joint 16, the controller 52 receives and monitors pressure signals from the pressure sensor 50. A monitored pressure below a threshold amount indicates a low internal weld pressure caused by insufficient materials in the weld joint. In such cases, the controller 52 actuates the plunger actuator 48 to inject more metal materials into the weld joint. This actively compensates for low weld pressures in the weld joint caused by gaps, voids, and other material deficiencies in the workpieces 12, 14. Conversely, a monitored pressure above a second, higher threshold amount indicates a high internal weld pressure caused by ample or even surplus materials in the weld joint. In such cases, the controller 52 deactuates the plunger actuator 48 to cease or decrease the injection of filler materials into the weld joint 16. Thus, the controller 52 attempts to maintain an internal weld pressure between the lower and higher threshold levels to compensate for gaps, voids, and other material deficiencies in the workpieces 12,14 without overfilling the weld joint with filler materials.

Methods of operating the above described friction stir welding machine 10 will now be described with reference to FIG. 4. Workpieces 12, 14 to be welded are first positioned between the upper and lower shoulders 22, 24 of the pin tool 18 as depicted in step 400 of FIG. 4 and as illustrated in FIG. 1. Forge forces are then applied to the workpieces 12, 14 by moving the upper and lower shoulders 22, 24 toward one another. The pin 26 is then inserted the joint 16 between the workpieces as depicted in step 402 and rotated and moved transversely along the joint as depicted in step 404.

As the pin is rotated, the pressure sensor 50 measures internal weld pressures adjacent the rotating pin, and the controller 52 monitors the weld pressures as depicted in step 406. If insufficient weld pressures are present as determined by step 408, the controller 52 actuates the plunger actuator 48 or otherwise calls for more filler materials to be injected into the weld joint as depicted in step 410.

While the above-described invention is particularly useful in friction stir welding applications, the principles of the invention may also be applied to ultrasonic forging, sonic forging, and other related forging applications.

### ADDITIONAL CONSIDERATIONS

References to “one embodiment,” “an embodiment,” or “embodiments” in this application mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Embodiments of the invention include the controller 52 for implementing logic or a number of routines, subroutines, applications, or instructions. The controller 52 may constitute either software (e.g., code embodied on a machine-readable medium or in a transmission signal) or hardware. In hardware, the routines, etc., are tangible units capable of performing certain operations and may be configured or arranged in a certain manner. The illustrated controller 52 and/or other devices may be configured by software (e.g., an application or application portion) or as computer hardware that operates to perform certain operations as described herein.

The controller 52 may include processing elements such as dedicated circuitry or logic that is permanently configured, such as an application-specific integrated circuit (ASIC), or indefinitely configured, such as an FPGA, to perform certain operations. The processing elements may also comprise programmable logic or circuitry (e.g., as encompassed within a general-purpose processor or other programmable processor) that is temporarily configured by software to perform certain operations.

Accordingly, the term “controller”, “processing element”, or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a hardware configuration at one instance of time and to constitute a different hardware configuration at a different instance of time.

Electronic components, such as the controller 52, the pressure sensor 50, communication elements, memory elements, processing elements, and the like, may provide information to, and receive information from, other electronic components. Accordingly, the described components may be regarded as being communicatively coupled. Where multiple electronic components exist contemporaneously, communications may be achieved through signal transmission (e.g., over appropriate circuits and buses) that connect the components. In embodiments in which multiple components are configured or instantiated at different times, communications between such components may be achieved, for example, through the storage and retrieval of information in memory structures to which the components have access. For example, one component may perform an operation and store the output of that operation in a memory device to which it is communicatively coupled. A further component may then, later, access the memory device to retrieve and process the stored output. Electronic components may also initiate communications with input or output devices, and may operate on a resource (e.g., a collection of information).

The various operations of example methods described herein may be performed, at least partially, by the controller 52 and/or one or more other processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of joining workpieces via friction stir welding, the method comprising:
placing the workpieces adjacent one another with a joint between them;
inserting a pin of a pin tool in the joint;
rotating the pin;
moving the pin tool along the joint as the pin is rotating to mix and heat materials in the joint;
monitoring internal weld pressures in the joint; and
injecting metal materials into the joint when the monitoring step detects an internal weld pressure below a threshold weld pressure.

2. The method as set forth in claim 1, wherein the injecting step comprises extruding the metal materials into the joint from a chamber in which the metal materials are held.

3. The method as set forth in claim 2, wherein the extruding step comprises pushing the metal materials in the chamber through an injection port with a plunger positioned in the chamber.

4. The method as set forth in claim 3, wherein the monitoring step comprises monitoring back pressures exerted on the plunger by the metal materials extruded from the injection port.

5. The method as set forth in claim 3, wherein the injection port and chamber are formed inside the pin tool so that the metal materials held in the chamber and extruded from the injection port are conductively heated by friction heat generated by the pin tool as the pin is rotated and moved along the joint.

6. The method as set forth in claim 1, wherein the metal materials are powder metal materials.

7. A method of joining two workpieces via friction stir welding, the method comprising:
placing the workpieces adjacent one another in an abutting relationship with a joint formed between them;
positioning an upper shoulder of a pin tool on an upper side of the joint;
positioning a lower shoulder of the pin tool on a lower side of the joint;
moving the upper and lower shoulders toward one another to apply forging and pinching forces on the joint;
inserting a pin of the pin tool in the joint;
rotating the pin;
moving the pin tool along the joint as the pin is rotated to mix and heat materials in the joint;
monitoring internal weld pressures in the joint adjacent the pin; and
injecting powdered metal materials into the joint when the monitoring step detects an internal weld pressure below a threshold weld pressure.

8. The method as set forth in claim 7, wherein the injecting step comprises extruding the powdered metal materials into the joint with a plunger connected to a chamber in which the powdered metal materials are held.

9. The method as set forth in claim 8, wherein the monitoring step comprises monitoring back pressures exerted on the plunger by the powdered metal materials extruded from the chamber.

10. The method as set forth in claim 8, wherein the chamber and an injection port are formed inside the pin tool so that the powdered metal materials held in the chamber and extruded from the injection port are conductively heated by friction heat generated by the pin as it is rotated and moved along the joint.

11. A friction stir welding machine comprising:
a pin tool comprising—
an upper shoulder;
a lower shoulder spaced from the upper shoulder to form a gap therebetween for accommodating edges of two abutting workpieces; and
a pin extending between the upper shoulder and the lower shoulder;
a drive spindle for rotating the pin and translating the pin tool along the joint as the pin rotates; and
an additive material assembly for adding filler materials to the joint when internal weld pressures in the joint drop below a threshold weld pressure.

12. The friction stir welding machine of claim 11, wherein the additive material assembly includes a chamber formed inside the pin tool.

13. The friction stir welding machine of claim 11, wherein the filler materials are powdered metals.

14. The friction stir welding machine of claim 13, wherein the additive material assembly comprises a chamber for holding the powdered metal materials.

15. The friction stir welding machine of claim 14, wherein the additive material assembly further comprises an injection port on one end of the chamber.

16. The friction stir welding machine of claim 15, wherein the additive material assembly further comprises a plunger positioned in the chamber for extruding the powdered metal materials from the chamber and out the injection port.

17. The friction stir welding machine of claim 16, wherein the additive material assembly further comprises a pressure sensor for monitoring internal weld pressures in the joint adjacent the pin as the pin rotates in the joint.

18. The friction stir welding machine of claim 17, wherein the additive material assembly further comprises a controller for actuating a plunger actuator coupled with the plunger to extrude powdered metal materials into the joint when the pressure sensor detects an internal weld pressure below a threshold weld pressure.

19. The friction stir welding machine of claim 18, wherein the controller de-activates the plunger actuator to stop extruding powdered metal materials into the joint when the pressure sensor detects an internal weld pressure above a second threshold weld pressure.

20. The friction stir welding machine of claim 11, wherein the workpieces are skin panels of an aircraft.
